(19) United States
(12) Patent Application Publication
(10) Pub. No.: US 2017/0210510 A1
(43) Pub. Date: Jul. 27, 2017

(54) CLOSURE DEVICE FOR BAGS HAVING A TACTILE AND SOUND EFFECT, BAG COMPRISING SUCH A DEVICE AND METHOD FOR PRODUCING SUCH A DEVICE

(71) Applicant: S2F FLEXICO, Henonville (FR)

(72) Inventors: Henri Bois, Neuilly-sur-Seine (FR); Isabelle Moulin, Paris (FR)

(21) Appl. No.: 15/438,526

(22) Filed: Feb. 21, 2017

Related U.S. Application Data
(63) Continuation of application No. 14/359,561, filed on Sep. 22, 2014, now abandoned.

(30) Foreign Application Priority Data
Nov. 21, 2011 (FR) 1160605

(51) Int. Cl. B65D 33/25; B29D 5/10

(52) U.S. Cl. CPC B65D 33/255; B65D 33/2558; B29D 5/10

(57) ABSTRACT

The present invention relates to a closure device for bags or the like comprising two complementary profiled elements (110, 210), characterized in that it involves sequential squeezing (300), of the two engaged profiled elements (110, 210), in a direction perpendicular to the support webs (100, 200).

The present invention relates to the field of closure devices for bags, sacks or the like.

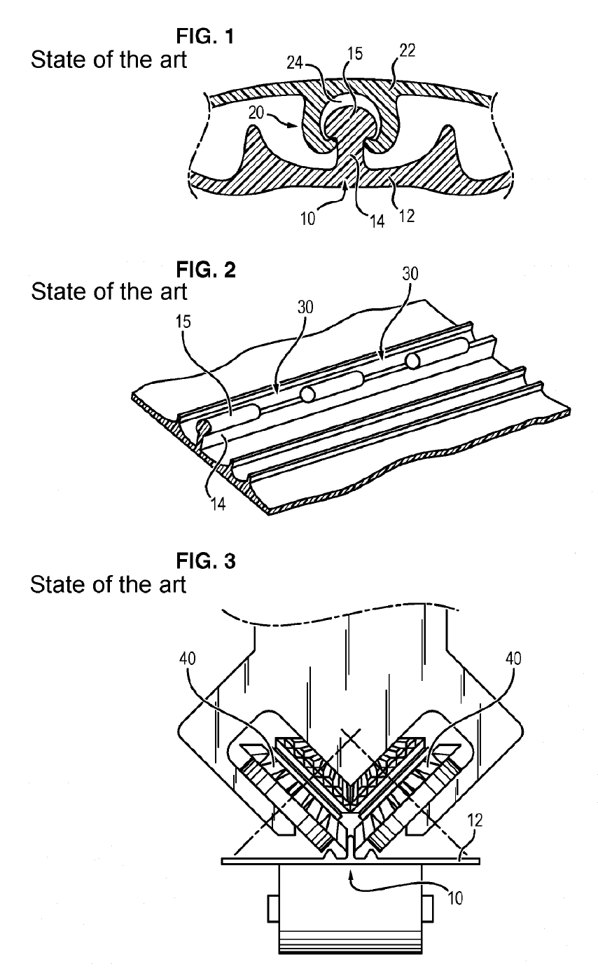

More specifically, the present invention relates to closure devices based on two complementary profiles 10, 20, borne by respective opposite support webs or walls 12, 22 as illustrated as a non-limiting example in the appended FIG. 1.

Many alternative embodiments of the device illustrated in FIG. 1 have already been proposed and fall within the scope of the present invention.

Generally, the aforementioned complementary profiles are formed with the complementary male/female elements, the male element comprising a rod 14 secured to the web or to the wall 12 and provided with a widened protrusion 15 at its top, while the female element 20 is formed with a groove 24 with convergent edges having as a section, a complementary cavity of the protrusion 15.

The general purpose of the present invention is to propose enhancements to the thereby known profiles in order to generate a tactile sensation and a sound effect upon closing or opening the aforementioned device, i.e. upon engaging the profiles 10, 20 and separating the latter.

Various arrangements have already been proposed in order to generate such tactile sensations and sound effects upon closing and opening the aforementioned device.

Examples of such known arrangements are described in documents WO 96/28063, U.S. Pat. No. 5,070,584 and EP 0 446 760. These documents disclose means as illustrated in the appended FIGS. 2 and 3. As seen in FIG. 2, the known arrangements most often consists of performing sequential deformation or cutting 30 along one of the two profiles, for example the male profile 10 according to the illustration of FIG. 2, in order to thereby define a succession of hard points and of weak points in the respective engagement of the elements 10, 20.

As illustrated in FIG. 3, the known means for making such closing devices according to the prior art, generally proceed with squeezing or lateral cutting with removal of material from one of the profiles, for example the male profile 10, by means of notched knurls 40 driven into rotation around a general axis transverse to the support webs or walls 12 of the relevant profile, i.e. along a thickness deformation or modification direction parallel to the support webs or walls 12.

Document US 2003/033694 as for it, proposes transverse deformation by compression of complementary profiles, in order to generate local deflections allowing generation of sound effects upon actuation of the device. Nevertheless, alternatives are sought today for enhancing these sound effects upon fitting together and separating complementary profiles without however making their manufacturing method complex.

Within this context, the particular object of the present invention is to improve the known arrangements from the prior art, in order to reinforce the tactile sensation and the sound effect.

This object is achieved within the scope of the present invention, by a closure device for bags or the like comprising two complementary profiles borne by respective support webs, characterized by the fact that it has sequential crushings of the two engaged profiles along a direction perpendicular to the support webs, so that the sequential crushings flare of two complementary profiles in the direction of the width transverse to the elongation direction of the closure device.

The present invention also relates to the bags or sacks equipped with such a closure device.

The present invention also relates to a method for making such closure devices or bags comprising a sequential squeezing step of two complementary profiles along a direction perpendicular to the support webs or walls of the complementary profiles.

Other features, objects and advantages of the present invention will become apparent upon reading the detailed description which follows, and with reference to the appended drawings given as non-limiting examples and wherein:

FIGS. 1, 2 and 3 described earlier respectively illustrate a transverse sectional view of a closure device according to the state of the art which may be used within the scope of the present invention, a partial perspective view of a closure device having sequential cutouts compliant with the state of the art and a tool according to the state of the art including two lateral squeezing knurls over a closure profile, movable along an axis of rotation globally transverse to the support webs of said profile,

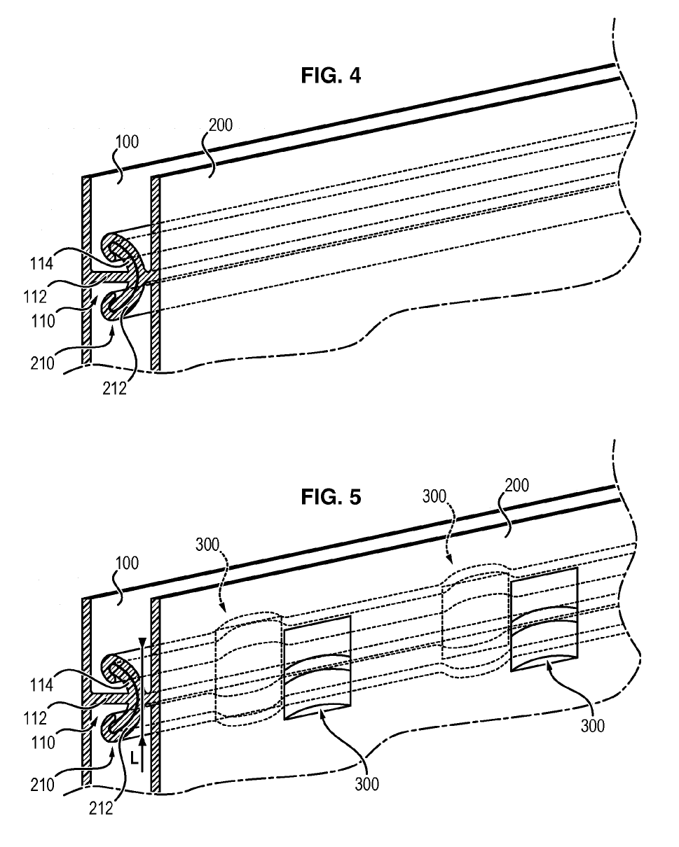

FIG. 4 illustrates a partial perspective schematic view of a closure device before squeezing according to the present invention,

FIG. 5 illustrates the same closure device in a partial perspective view after sequential squeezing according to the present invention,

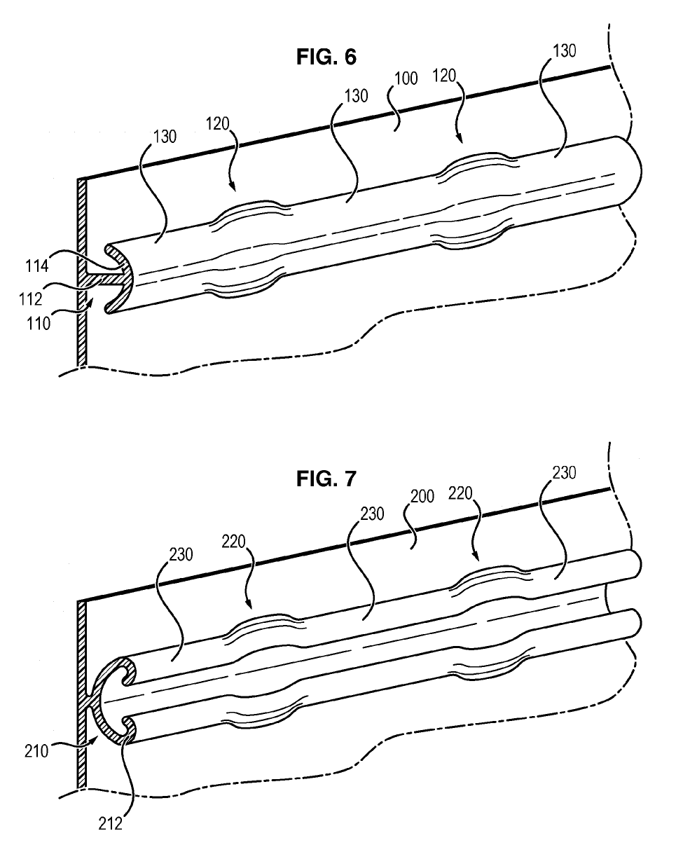

FIGS. 6 and 7 respectively illustrate individual views of a male profile and of a female profile forming as a combination a closure device according to the present invention illustrated in FIG. 5,

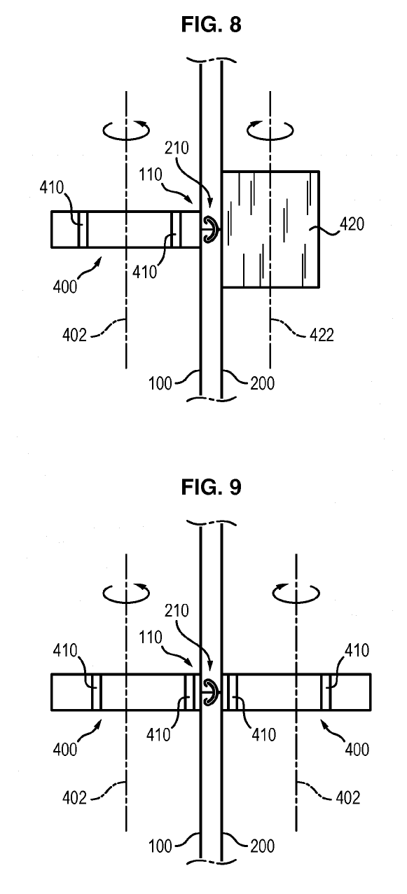

FIG. 8 illustrates a transverse sectional view of a closure device being squeezed according to the present invention and of the tool used for this purpose,

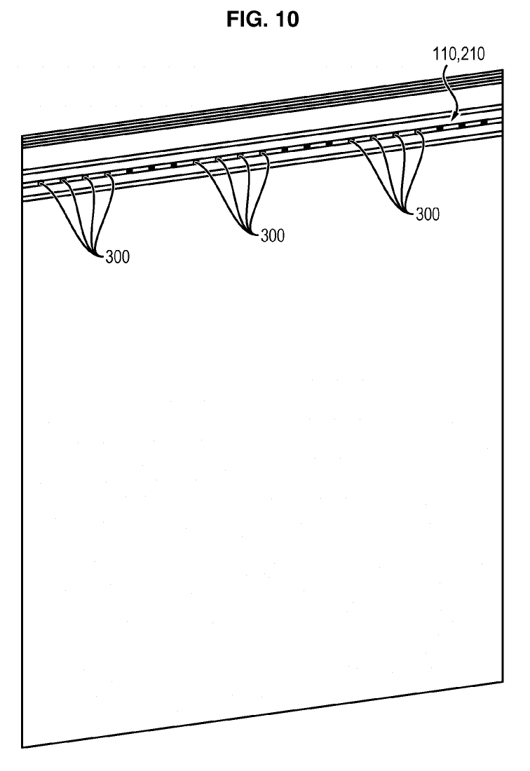

FIG. 9 illustrates an alternative of a transverse sectional view of a closure device being squeezed according to the present invention and of the alternative tool used for this purpose,

FIG. 10 illustrates a perspective view of a bag according to the present invention comprising sequential crushings made according to the modalities of the invention,

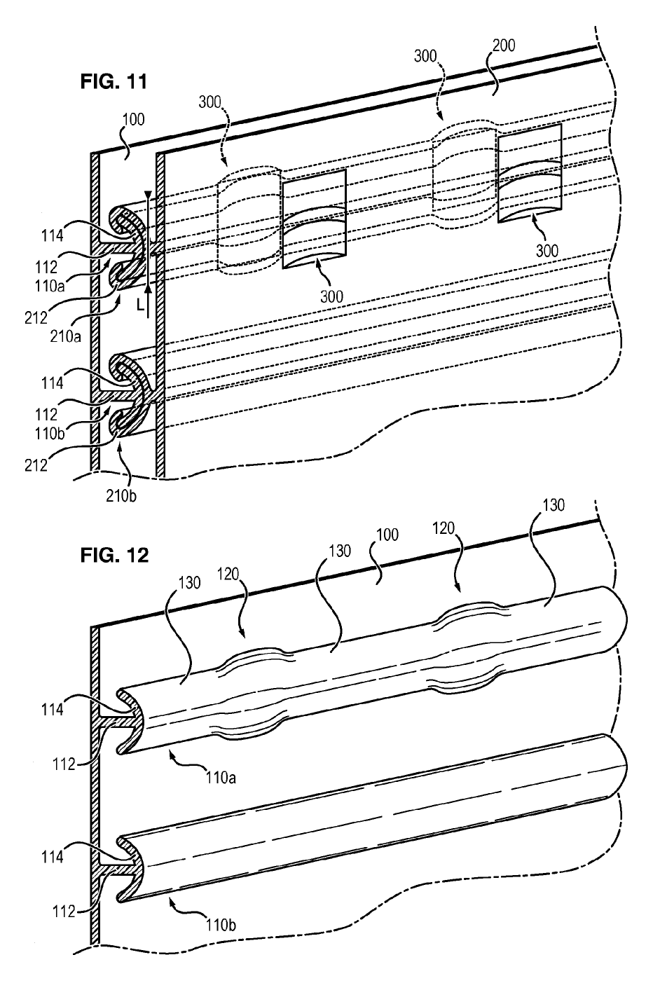

FIGS. 11, 12 and 13 respectively illustrate for a first alternative embodiment of a closure device according to the present invention comprising two pairs of parallel complementary closure profiles, a partial perspective view of the closure device after sequential squeezing of a pair of profiles and individual views of male profiles and of female profiles for forming as a combination a closure device according to the present invention illustrated in FIG. 11,

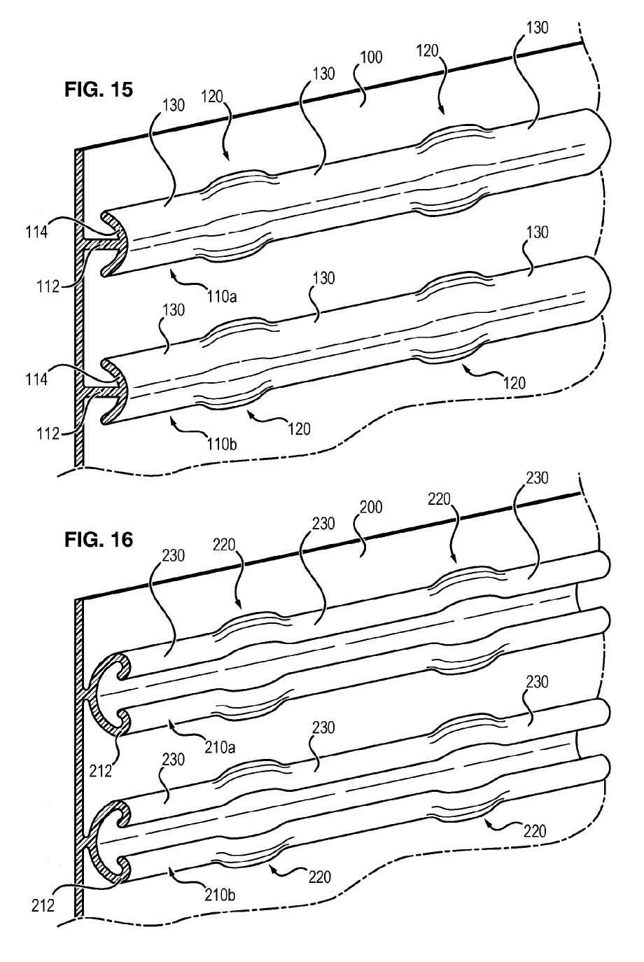

FIGS. 14, 15 and 16 respectively illustrate, for a second alternative embodiment of a closure device according to the present invention comprising two pairs of parallel complementary closure profiles, a partial perspective view of the closure device after sequential squeezing of both pairs of profiles and individual views of male profiles and of female profiles forming as a combination a closure device according to the present invention illustrated in FIG. 14,

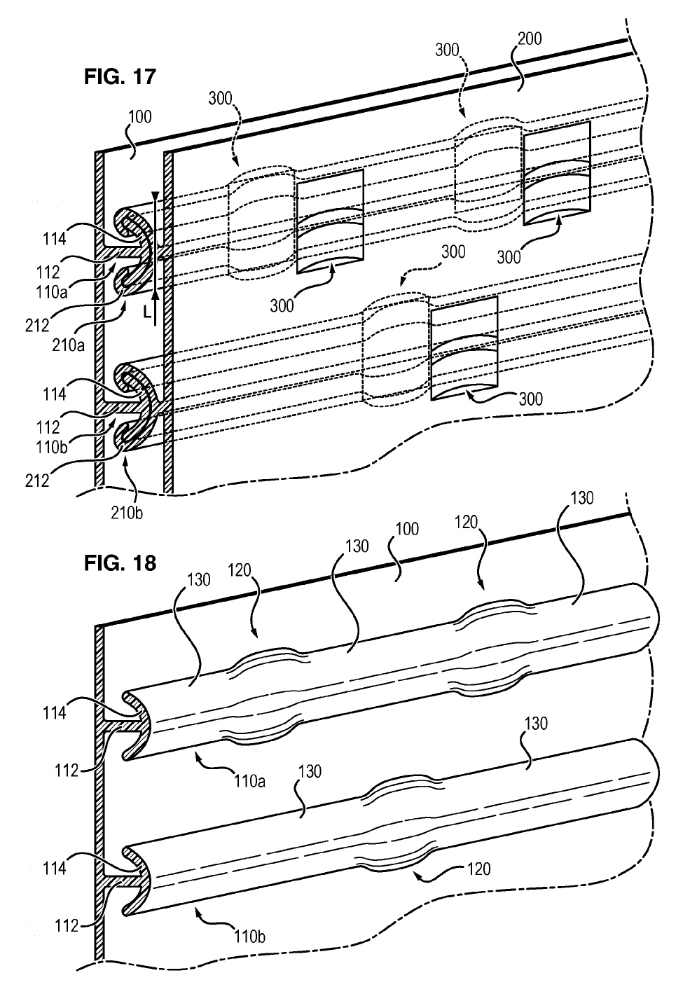

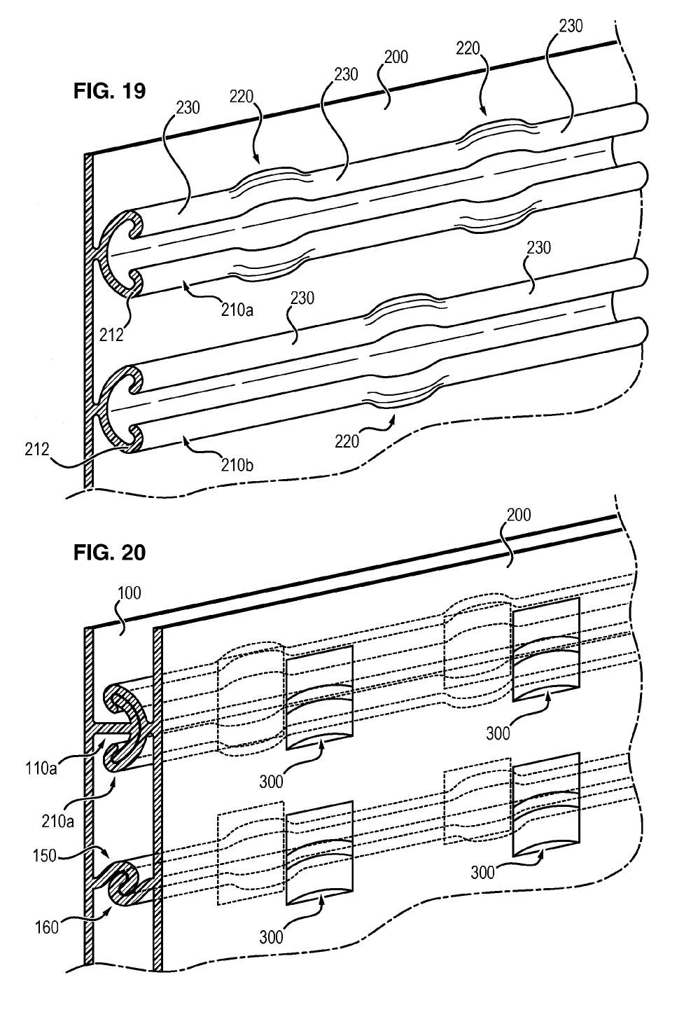

FIGS. 17, 18 and 19 respectively illustrate, for a third alternative embodiment of a closure device according to the present invention comprising two pairs of parallel complementary closure profiles, a partial perspective view of the closure device after sequential squeezing of both pairs of profiles and individual reviews of male profiles and of female profiles forming as a combination a closure device according to the present invention illustrated in FIG. 17, and

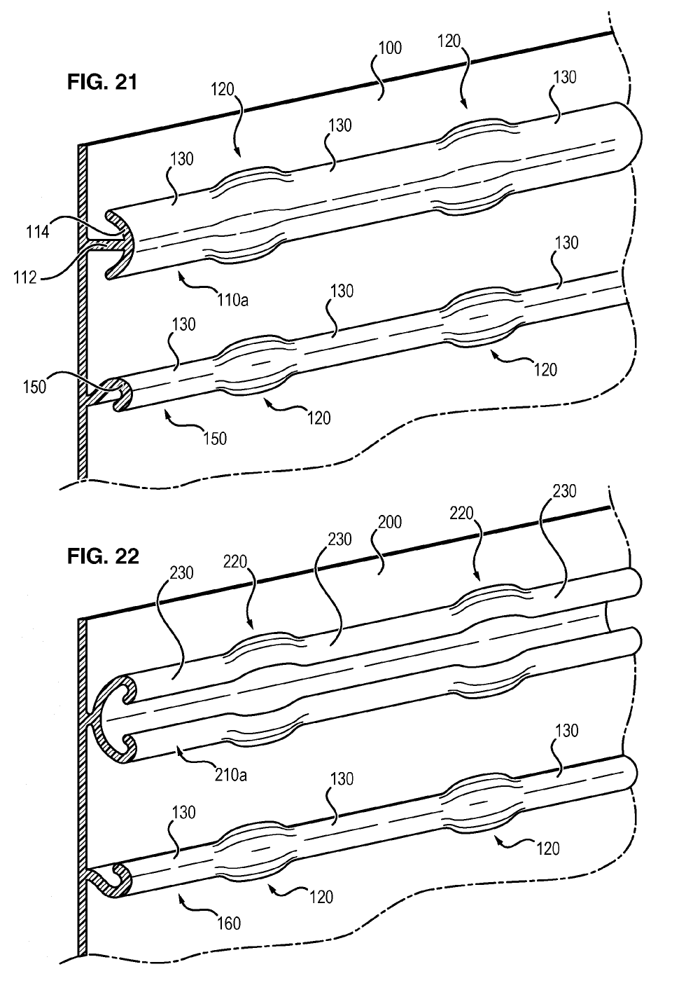

FIGS. 20, 21 and 22 respectively illustrate, for a fourth alternative embodiment of a closure device according to the present invention comprising two pairs of parallel complementary closure profiles, one of the male/female complementary types and the other of the complementary hook type, a partial perspective view of the closure device after sequential squeezing and individual views of the profiles borne by opposite support films and forming as a combination a closure device according to present invention illustrated in FIG. 20.

A closure device comprising two support webs 100, 200 respectively bearing two complementary profiles 110, 210, is illustrated in the appended FIG. 4.

According to the particular embodiment illustrated in FIG. 4, the first profile 110 comprises a rod 112 globally perpendicular to the support web 100 and provided at its top opposite to the support web 100, with a flared protrusion 114. The complementary female profile 210 as for it, essentially comprises a groove with convergent edges 212 defining in the section a cavity complementary the flared protrusion 114.

The complementary closure profiles 110 and 210 have constant section over their length. They are preferably made by extrusion. Such a closure device will not be described in more detail in its initial structure, insofar that such closure devices are well known to one skilled in the art, and may give rise to many embodiments or alternatives. For example mention will be made of an alternative embodiment wherein the closure device includes two complementary profiles 110, 210, not in the form of a complementary male element or female element but in the form of simple complementary hooks.

Moreover, within the scope of the present invention, either a closure device may be contemplated comprising both separately made closure profiles 110, 210 of a bag, and then added and attached, for example by thermal welding on films making up a bag or further a closure device directly made from a material by extrusion, with films forming the walls of the bag.

As indicated earlier, within the scope of the present invention, the complementary profiles 110, 210 are sequentially squeezed in their assembled position as illustrated in FIG. 4 according to squeezing in a direction perpendicular to the support webs and walls 100, 200. It will be understood here that as opposed to the deflections notably proposed by document US 2003/0033694, the sequential crushings according to the invention produces flaring of two complementary profiles in the direction of the width, and transverse to the elongation direction of the closure device, and do not simply corresponds to local distortion of the profiles in the transverse direction.

FIG. 5 illustrates the thereby obtained squeezing areas at the area referenced as 300. Preferably, the squeezing areas 300 cover the whole length L of the relevant profiles perpendicularly to their elongation direction.

In FIGS. 6 and 7, a male profile 110 and a female profile 210 thus sequentially squeezed according to the present invention are illustrated. In FIGS. 6 and 7, sequential flarings 120, 220 along the width transverse to the elongation direction are observed, both of the male profile 110 and of the female profile 210. However, as the sequential squeezing is achieved according to the present invention in the assembled position of both profiles 110, 210, it is guaranteed that the cross-sections both of the male profile 110 and of the female profile 210, although deformed in their width remained perfectly paired, complementary each other to a certain extent, and both compatible for closing, i.e. engagement, and for opening, i.e. separation.

As illustrated in FIG. 8, the sequential crushings may be achieved within the scope of the present invention, by means of a notched knurl 400 with peripheral protrusions 410 at the desired pitch of the sequential crushings 300, urging one side of the closure device and a simple support roller 420 located on the opposite side.

The knurl 400 and the support roller 420 illustrated in FIG. 8 are driven into rotation around axes 402, 422, parallel with each other and parallel to the support webs 100, 200.

An alternative embodiment is illustrated in the appended FIG. 9, according to which the sequential squeezing according to the present invention is achieved by means of two notched rollers or knurls 400 positioned on either side of the closure device, the notched rollers 400 comprising protrusions 410 with the pitch of the desired crushings 300 and then again being driven into rotation about axes 402 parallel with each other and parallel to the support webs 100, 200. Both knurls 400 are synchronized so that their respective protrusions simultaneously urge and squeeze the profiles 110, 210.

The closing devices according to the present invention may be made on the basis of any suitable material, preferably on the basis of a polyolefin.

One skilled in the art will understand that by achieving crushings of both complementary profiles 110, 210 in the assembled position of the latter, it is possible to reinforce the tactile sensation and the clicking sound effect notably obtained upon opening the device, but also upon its closing, urge you to the succession of hard points and weak points in the thereby defined engagement and separation, in the longitudinal direction of the closure.

With the present invention, it is actually possible to obtain a large sequential deformation of both complementary profiles 110, 210, while guaranteeing their engagement and separation possibility, insofar that the achieved crushings 300 mate each other perfectly, since they are achieved in a closed position of both profiles.

It will be noted that the presence of segments 130, 230 with constant section and therefore the easy engagement of these segments between two crushings 300 give the possibility by simply sliding between the fingers of a user of prolonging the engagement obtained at such segments 130, 230, with a constant section to wards the deformed squeezing areas 300.

The reinforcement of the tactile sensation and of the sound effect obtained by means of the present invention thus results from the common widening achieved on both profiles.

As a non-limiting example, the pitch of the achieved sequential crushings is comprised between 4 mm and 1 cm.

Moreover, within the scope of the present invention, the squeezing is preferably achieved so that widening is obtained in the direction of the width L of the profiles, at least equal to 5% of the original width L, preferably greater than 10% of this width L.

The squeezing knurls 400 and if required the support roller 420 may be heated in order to reinforce the deformation by squeezing of the closure profiles and guarantee the maintaining thereof in the sequential squeezing position.

However, if the material allows this, the crushings may be achieved by means of simple knurls 400 at room temperature.

According to still another alternative, the sequential crushings may be achieved with room temperature knurls, but operating on a softened closure, i.e. deformed by hot extrusion upon exiting the latter.

FIG. 10 illustrates a bag according to the present invention. A squeezing series distributed over the length of the closure device is seen in FIG. 10.

Of course, the present invention is not limited to the particular embodiments which have just been described, but extends to any alternative compliant with its spirit.

As illustrated in FIGS. 11 to 22, according to alternative embodiments compliant with the present invention, the closure device may comprise at least two pairs of parallel complementary profiles. This arrangement gives the possibility of notably reinforcing the seal of the bags once they are closed and of limiting the risks of untimely opening under the effect of the internal pressure of the bags.

In this case, provision may be made for having both pairs of parallel profiles sequentially squeezed simultaneously with the same pitch and synchronized as in illustrated in FIGS. 14 to 16, or with a longitudinal shift as illustrated in FIGS. 17 to 19 (or further with different or submultiple pitches from one pair of profiles to the other and this without or with a longitudinal shift) or having only a squeezed pair of profiles as illustrated in FIGS. 11 to 13.

As illustrated in FIGS. 20 to 22, if required at least one of the pair of profiles may be formed with hook-shaped complementary profiles 150, 160.

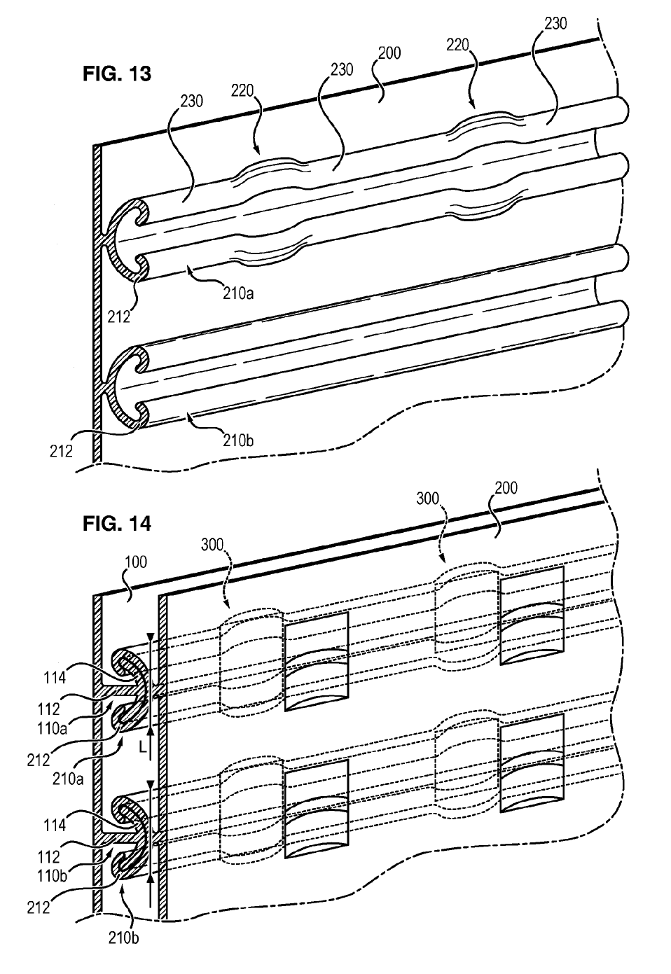

A first alternative embodiment of a closure device according to the present invention is illustrated in FIGS. 11, and 13, comprising two pairs of parallel complementary closure profiles 110a/210a and 110b/210b. More specifically, FIGS. 11, 12 and 13 respectively illustrate a partial perspective view of the closure device after sequential squeezing of a pair of profiles 110a/210a (the second pair of profiles 110b/210b is not squeezed) and individual views of male profiles 110a and 110b and of female profiles 210a and 210b forming as a combination a closure device according to the present invention illustrated in FIG. 11.

A second alternative embodiment of a closure device according to the present invention is illustrated in FIGS. 14, and 16, comprising two pairs of parallel complementary closure profiles 110a/210a and 110b/210b. More specifically, FIGS. 14, 15 and 16 respectively illustrate a partial perspective view of the closure device after sequential squeezing of both pairs of profiles 110a/210a and 110b/210b and individual views of male profiles 110a and 110b and of female profiles 210a and 210b forming as a combination a closure device according to the present invention, illustrated in FIG. 14.

A third alternative embodiment of a closure device according to the present invention is illustrated in FIGS. 17, 18 and 19, comprising two pairs of parallel complementary closure profiles 110a/210a and 110b/210b. More specifically, FIGS. 17, 18 and 19 respectively illustrate a partial perspective view of the closure device after sequential squeezing of both pairs of profiles 110a/210a and 110b/210b with a longitudinal shift between the crushings achieved on both pairs of profiles and individual views of male profiles 110a and 110b and of female profiles 210a and 210b forming as a combination a closure device according to the present invention, illustrated in FIG. 17.

A fourth alternative embodiment of a closure device according to the present invention is illustrated in FIGS. 20, and 22, comprising two pairs of parallel complementary closure profiles, one of the male/female complementary type 110/210 and the other of the complementary hook type 150/160. More specifically, FIGS. 20, 21 and 22 respectively illustrate a partial perspective view of the closure device after sequential squeezing and individual views of the profiles borne by opposite support films and forming as a combination a closure device according to the present invention, illustrated in FIG. 20.

1. A closure device for bags or the like comprising two complementary profiles (110, 210) borne by respective support webs (100, 200), wherein said complementary profiles are engagable and extend along a first direction and have a width which extends transverse to said first direction, and said profiles each have sequential crushings (300) which extend along a the first direction and form flarings (120, 220) having a width which extends in a direction transverse to said first direction, wherein when said profiles are engaged, said crushings create a succession of hard points and weak points of engagement along said first direction.

2. The device according to claim 1, wherein the complementary profiles (110, 210) are of the male/female or hook type.

3. The device according to claim 1, wherein the device is made of polyolefin.

4. The device according to claim 1, wherein the pitch of the sequential crushings (300) is between 4 mm and 1 cm.

5. The device according to claim 1, wherein the sequential crushings (300) produce widening of the complementary profiles, at least equal to 5% of the initial width.

6. The device according to claim 1, wherein the closure device comprises at least two pairs of parallel complementary profiles (110a, 110b and 210a, 210b; 110a, 110b; 150, 160).

7. The device according to claim 6, wherein the two pairs of parallel profiles (110a, 110b and 210a, 210b; 110a, 110b; 150, 160) are sequentially crushed simultaneously.

8. The device according to claim 6, wherein the two pairs of parallel profiles (110a, 110b and 210a, 210b; 110a, 110b; 150, 160) are sequentially crushed with the same pitch simultaneously.

9. The device according to claim 6, wherein the two pairs of parallel profiles (110a, 110b and 210a, 210b; 110a, 110b; 150, 160) are sequentially crushed with the same pitch simultaneously and synchronously.

10. The device according to claim 6, wherein the two pairs of parallel profiles (110a, 110b and 210a, 210b; 110a, 110b; 150, 160) are sequentially crushed with the same pitch and with a respective longitudinal shift, simultaneously.

11. (canceled)

12. The device according to claim 6, wherein only one pair of profiles (110, 210) is crushed.

13. A bag comprising a closure device according to claim 1.

14. A method for making a closure device for bags or the like comprising two complementary profiles borne by respective support webs, wherein said complementary profiles are engagable and extend along a first direction and have a width which extends transverse to said first direction, and said method comprises a step for sequentially crushing both profiles (100, 200) of the closure device along a direction which is transverse to the first direction, so that said profiles each have sequential crushings (300) which extend along the first direction and form flarings (120, 220) having a width which extends in a direction transverse to said first direction, wherein when said profiles are engaged, said crushings create a succession of hard points and weak points of engagement along said first direction.

15. The method according to claim 14, wherein said method is performed by driving two notched knurls (400) respectively positioned on either side of the closure device into rotation about axes (402) parallel to the support webs of the device.

16. The method according to claim 14, wherein said method is performed by driving one notched knurl (400) and support roller (420) respectively positioned on either side of the closure device into rotation about axes (402, 422) parallel to the support webs of the closure device.
